(19) United States
(12) Patent Application Publication
(10) Pub. No.: US 2009/0050535 A1
(43) Pub. Date: Feb. 26, 2009

(54) REACTOR SYSTEM, AND A PROCESS FOR PREPARING AN OLEFIN OXIDE, A 1,2-DIOL, A 1,2-DIOL ETHER, A 1,2-CARBONATE AND AN ALKANOLAMINE

(76) Inventor: Wayne Errol Evans, Richmond, TX (US)

Correspondence Address: SHELL OIL COMPANY, P O BOX 2463, HOUSTON, TX, 772522463, US

(21) Appl. No.: 12/121,714

(22) Filed: May 15, 2008

Related U.S. Application Data
(60) Provisional application No. 60/938,907, filed on May 18, 2007.
(60) Provisional application No. 60/948,124, filed on Jul. 5, 2007.

(51) Int. Cl. C10G 29/04; B01J 19/00

(52) U.S. Cl. 208/246; 422/211; 208/247

(57) ABSTRACT

The present invention provides an epoxidation reactor system for preparing an olefin oxide comprising:
one or more purification zones comprising one or more purification vessels containing an absorbent comprising copper and zinc; and
a reaction zone comprising one or more reactor vessels containing an epoxidation catalyst, wherein the reaction zone is positioned downstream from the one or more purification zones;
a process for preparing an olefin oxide; and a process for preparing a 1,2-diol, a 1,2-diol ether, a 1,2-carbonate, and an alkanolamine.

### CROSS-REFERENCE TO RELATED APPLICATIONS

This application claims the benefit of U.S. Provisional Patent Application No. 60/938,907, filed May 18, 2007, and U.S. Provisional Patent Application No. 60/948,124, filed Jul. 5, 2007, both of which are incorporated herein by reference in their entirety.

### FIELD OF THE INVENTION

The invention relates to a reactor system for preparing an olefin oxide and a process for preparing the olefin oxide which utilizes the inventive reactor system. The invention also relates to a process which uses the olefin oxide so produced for making a 1,2-diol, a 1,2-diol ether, a 1,2-carbonate, or an alkanolamine.

### BACKGROUND OF THE INVENTION

In olefin epoxidation, a feed containing an olefin and oxygen is contacted with a silver-based catalyst under epoxidation conditions. The feed may also contain reaction modifiers and dilution gases such as saturated hydrocarbons or inert gases. The olefin is reacted with oxygen to form an olefin oxide. A reaction product results that contains olefin oxide and, typically, unreacted feed, dilution gases, reaction modifiers, and combustion products.

Of particular concern in the epoxidation process are trace sulfur impurities that may be present in the feedstream. The sulfur impurities present in the feedstream may originate from the olefin. An olefin such as ethylene may be derived from several sources including, but not limited to, petroleum processing streams such as those generated by a thermal cracker, a catalytic cracker, a hydrocracker or a reformer, natural gas fractions, naphtha and organic oxygenates such as alcohols. The silver-based catalysts used in an epoxidation process are especially susceptible to catalyst poisoning even at impurity amounts on the order of parts per billion levels. The catalyst poisoning impacts the catalyst performance, in particular the selectivity or activity, and shortens the length of time the catalyst can remain in the reactor before having to exchange the poisoned catalyst with fresh catalyst.

Thus, there exists a desire for an epoxidation reactor system and an epoxidation process that further improves the performance of the catalyst, in particular the duration of time the catalyst remains in the reactor before exchanging with a fresh catalyst.

### SUMMARY OF THE INVENTION

The present invention provides an epoxidation reactor system for preparing an olefin oxide comprising:

one or more purification zones comprising one or more purification vessels containing an absorbent comprising copper and zinc; and

a reaction zone comprising one or more reactor vessels containing an epoxidation catalyst, wherein the reaction zone is positioned downstream from the one or more purification zones.

The invention also provides a process for preparing an olefin oxide by reacting a feed comprising one or more feed components comprising an olefin and oxygen, which process comprises:

contacting one or more of the feed components with an absorbent comprising copper and zinc positioned within a reactor system according to the present invention to reduce the quantity of one or more impurities in the feed components; and

subsequently contacting the feed components with an epoxidation catalyst to yield an olefin oxide.

Further, the invention provides a process of preparing a 1,2-diol, a 1,2-diol ether, a 1,2-carbonate, or an alkanolamine comprising obtaining an olefin oxide by the process according to this invention, and converting the olefin oxide into the 1,2-diol, the 1,2-diol ether, the 1,2-carbonate, or the alkanolamine.

### BRIEF DESCRIPTION OF THE DRAWINGS

FIG. 1 is a schematic view of a reactor system according to an embodiment of the invention which has a purification zone containing the absorbent and a reaction zone containing the catalyst.

### DETAILED DESCRIPTION OF THE INVENTION

It has been found that an absorbent comprising copper and zinc can be unexpectedly effective at reducing the amount of sulfur impurities, in particular dihydrogen sulfide, carbonyl sulfide, and mercaptans, in an epoxidation feed component. By reducing the amount of sulfur impurities which can act as catalyst poisons, the catalyst performance is improved, in particular the selectivity or activity of the catalyst and the duration of time the catalyst can remain in the reactor system.

The terms “substantially vertical” and “substantially horizontal”, as used herein, are understood to include minor deviations from true vertical or horizontal positions relative to the central longitudinal axis of the reactor vessel, in particular the terms are meant to include variations ranging from 0 to 20 degrees from true vertical or horizontal positions. True vertical is aligned along the central longitudinal axis of the reactor vessel. True horizontal is aligned perpendicular to the central longitudinal axis of the reactor vessel.

The term “substantially parallel”, as used herein, is understood to include minor deviations from a true parallel position relative to the central longitudinal axis of the reactor vessel, in particular the term is meant to include variations ranging from 0 to 20 degrees from a true parallel position relative to the central longitudinal axis of the reactor vessel.

Referring now to preferred embodiments of the invention, the purification of a feed component occurs within one or more purification zones which are upstream from the reaction zone comprising one or more reactor vessels. A purification zone may comprise one or more separate purification vessels containing a packed bed of the absorbent. The packed bed of the absorbent may be of any suitable height. The one or more purification zones may be used in series with the reactor vessel and are located upstream from the reactor vessel.

When the purification zone contains two or more purification vessels, the purification vessels may be arranged in parallel with associated switching means to allow the process to be switched between purification vessels, thus maintaining a continuous operation of the process. Suitable switching means that can be used in this embodiment are known to the skilled person.

The one or more reactor vessels contain one or more open-ended reactor tubes. Preferably, the reactor vessel is a shell-and-tube heat exchanger containing a plurality of reactor tubes. The reactor tubes may preferably have an internal diameter in the range of from 15 to 80 mm (millimeters), more preferably from 20 to 75 mm, and most preferably from 25 to 70 mm. The reactor tubes may preferably have a length in the range of from 5 to 20 m (meters), more preferably from 10 to 15 m. The shell-and-tube heat exchanger may contain from 1000 to 20000 reactor tubes, in particular from 2500 to 15000 reactor tubes.

The reactor tubes are positioned substantially parallel to the central longitudinal axis of the reactor vessel and are surrounded by a shell adapted to receive a heat exchange fluid (i.e., the shell side of the shell-and-tube heat exchanger). The heat exchange fluid in the heat exchange chamber (e.g., the shell side of an shell-and-tube heat exchanger) may be any fluid suitable for heat transfer, for example water or an organic material suitable for heat exchange. The organic material may be an oil or kerosene.

The upper ends of the reactor tubes are connected to a substantially horizontal upper tube plate and are in fluid communication with the one or more inlets to the reactor vessel and the lower ends of the reactor tubes are connected to a substantially horizontal lower tube plate and are in fluid communication with the one or more outlets to the reactor vessel (i.e., the tube side of the shell-and-tube heat exchanger). The reactor vessel contains a packed bed of catalyst particles positioned inside the reactor tubes.

The reactor tubes contain a catalyst bed. In the normal practice of this invention, a major portion of the catalyst bed comprises catalyst particles. By a “major portion” it is meant that the ratio of the weight of the catalyst particles to the weight of all the particles contained in the catalyst bed is at least 0.50, in particular at least 0.8, preferably at least 0.85, more preferably at least 0.9. Particles which may be contained in the catalyst bed other than the catalyst particles are, for example, inert particles; however, it is preferred that such other particles are not present in the catalyst bed. The catalyst bed is supported in the one or more reactor tubes by a catalyst support means arranged in the lower ends of the reactor tubes. The support means may include a screen or a spring.

The catalyst bed may have any bed height. Suitably, the catalyst bed may have a bed height of 100% of the length of the reactor tube. The catalyst bed may suitably have a bed height of at most 95% or at most 90%, or at most 85%, or at most 80% of the length of the reactor tube. The catalyst bed may suitably have a bed height of least 10% of the length of the reactor tube, in particular at least 25%, more in particular at least 50% of the length of the reactor tube.

The reactor tubes may also contain a separate bed of particles of an inert material for the purpose of, for example, heat exchange with a feedstream. The one or more reactor tubes may also contain another such separate bed of inert material for the purpose of, for example, heat exchange with the reaction product. Alternatively, rod-shaped metal inserts may be used in place of the bed of inert material. For further description of such inserts, reference is made to U.S. Pat. No. 7,132,555, which is incorporated by reference.

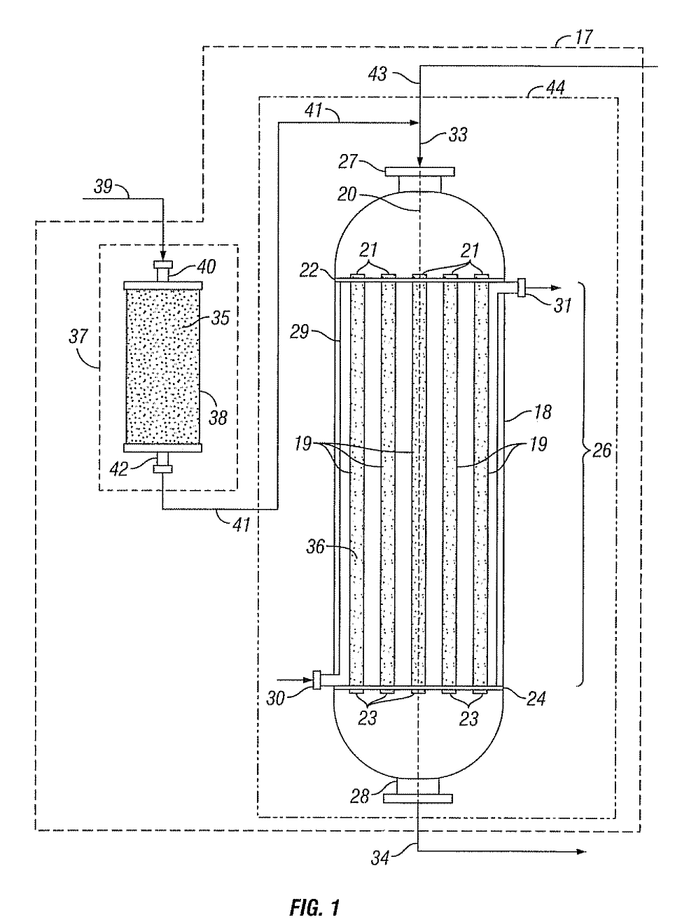

Reference is made to FIG. 1, which is a schematic view of a reactor system (17) containing a purification zone (37) and a reaction zone (44). The reaction zone (44) is positioned downstream from the purification zone and comprises a shell-and-tube heat exchanger reactor vessel having a substantially vertical vessel (18) and a plurality of open-ended reactor tubes (19) positioned substantially parallel to the central longitudinal axis (20) of the reactor vessel (18). The upper ends (21) of the reactor tubes (19) are connected to a substantially horizontal upper tube plate (22) and the lower ends (23) of the reactor tubes (19) are connected to a substantially horizontal lower tube plate (24). The upper tube plate (22) and the lower tube plate (24) are supported by the inner wall of the reactor vessel (18). The plurality of reactor tubes (19) contain a catalyst bed (26) containing a catalyst (36). The catalyst (36) is supported in the reactor tubes (19) by a catalyst support means (not shown) arranged in the lower ends (23) of the reactor tubes (19). Components of the feed, such as the olefin, enter the reactor vessel (18) via one or more inlets such as inlet (27) which are in fluid communication with the upper ends (21) of the reactor tubes (19). The reaction product (34) exits the reactor vessel (18) via one or more outlets such as outlet (28) which are in fluid communication with the lower ends (23) of the reactor tubes (19). The heat exchange fluid enters the heat exchange chamber (29) via one or more inlets such as inlet (30) and exits via one or more outlets such as outlet (31). The heat exchange chamber (29) may be provided with baffles (not shown) to guide the heat exchange fluid through the heat exchange chamber (29).

The purification zone (37) contains a separate purification vessel (38) positioned upstream from the reactor vessel (18). The purification vessel (38) contains a packed bed of absorbent (35). The feed components to be treated (39) enter the separate purification vessel (38) through inlet (40), and the treated feed components (41) exit the separate purification vessel (38) through the outlet (42). The treated feed components subsequently enter the reactor vessel (18) along with any additional feed components (43) as the feed (33) through inlet (27).

The absorbent comprises copper and zinc. The copper and zinc metals may be present in reduced or oxide form.

The absorbent may also contain an additional metal selected from cobalt, chromium, lead, manganese, and nickel. Preferably, the additional metal may be selected from chromium, manganese and nickel. These additional metals may be present in the reduced or oxide form.

The absorbent may also contain a support material. The support material may be selected from alumina, titania, silica, activated carbon or mixtures thereof. Preferably, the support material may be alumina, in particular alpha-alumina. Without wishing to be bound by theory, it is believed the absorbent reduces the impurities in the feed by chemical or physical means including, but not limited to, reaction with the impurities and absorption of the impurities.

The absorbent may be prepared by conventional processes for the production of such metal-containing materials, for example by precipitation or impregnation, preferably by precipitation. For example, in the precipitation process, suitable salts of copper and zinc, optional additional metal salt, and optional salt of the support material may be prepared by reacting the metals with a strong acid such as nitric acid or sulfuric acid. The resulting salts may then be contacted with a basic bicarbonate or carbonate solution in a pH range of from 6 to 9 at a temperature from 15 to 90° C., in particular 80° C., to produce a precipitate of metal oxide. The precipitate may be filtered and then washed at a temperature in the range of from 20 to 50° C. The precipitate may then be dried at a temperature in the range of from 100 to 160° C., in particular 120 to 150° C. After drying, the precipitate may then be calcined at a temperature in the range of from 170 to 600° C., in particular from 350 to 550° C. The precipitate may be formed into a desired size and shape by conventional processes such as extrusion or tableting. Alternatively, an impregnation process may be used to form the absorbent by impregnating the support material with suitable solutions of the metal compounds followed by drying and calcining.

The size and shape of the absorbent may be in the form of chunks, pieces, cylinders, rings, spheres, wagon wheels, tablets, and the like of a size suitable for employment in a fixed bed reactor vessel, for example from 2 mm to 30 mm. Preferably, the size and shape maximizes the surface area available for contact with the feed.

The absorbent after calcination may contain metal oxide in a quantity in the range of from 20 to 100% w (percent by weight), relative to the weight of the absorbent, in particular from 70 to 100% w, more in particular from 75 to 95% w, relative to the weight of the absorbent. As used herein, unless otherwise specified, the weight of the absorbent is deemed to be the total weight of the absorbent including the weight of the support material. The absorbent after calcination may contain copper oxide in a quantity of at least 8% w, preferably at least 10% w, more preferably at least 20% w, most preferably at least 30% w, relative to the weight of the absorbent. The absorbent after calcination may contain copper oxide in a quantity of at most 60% w, preferably at most 50% w, more preferably at most 45% w, relative to the weight of the absorbent. The absorbent after calcination may contain copper oxide in a quantity in the range of from 10 to 60% w (percent by weight), relative to the weight of the absorbent, in particular from 20 to 50% w, relative to the weight of the absorbent.

The support material may be present in the absorbent after calcination in a quantity of at least 1% w, relative to the weight of the absorbent, in particular at least 1.5% w, more in particular at least 2% w, relative to the weight of the absorbent. The support material may be present in the absorbent after calcination in a quantity of at most 80% w, relative to the weight of the absorbent, in particular at most 50% w, more in particular at most 30% w, relative to the weight of the absorbent, most in particular at most 25% w, relative to the weight of the absorbent. The support material may be present in the absorbent after calcination in a quantity in the range of from 5 to 25% w, in particular from 10 to 20% w, relative to the weight of the absorbent.

The absorbent after calcination may contain the copper and zinc oxides in a mass ratio of zinc oxide to copper oxide of at least 0.2, in particular at least 0.5, more in particular at least 0.7. The mass ratio of zinc oxide to copper oxide may be at most 10, in particular at most 8, more in particular at most 5. The mass ratio of zinc oxide to copper oxide may be in the range of from 0.5 to 10, in particular from 1 to 5, more in particular from 1.2 to 2.5, most in particular from 1.25 to 1.75.

The absorbent after calcination may contain the additional metal in the form of an oxide in a quantity in the range of from 1 to 20% w, relative to the weight of the absorbent, in particular from 2 to 15% w, more in particular from 5 to 10% w, same basis.

After calcination, the absorbent may be subjected to hydrogen reduction. Typically, hydrogen reduction may be conducted by contacting the absorbent with a hydrogen reduction stream at a temperature in the range of from 150 to 350° C. A suitable hydrogen reduction stream may contain hydrogen in the range of from 0.1 to 10% v (percent by volume) and nitrogen in the range of from 99.9 to 90% v, relative to the total reduction stream. After hydrogen reduction, the absorbent may be subjected to oxygen stabilization. Oxygen stabilization may be conducted by contacting the reduced absorbent at a temperature in the range of 60 to 80° C. with a gas stream containing oxygen in the range of from 0.1 to 10% v and nitrogen in the range of from 99.9 to 90% v, relative to the total stabilization stream.

The absorbent may contain a total amount of the metals (measured as the weight of the metal elements relative to the weight of the absorbent) in a quantity in the range of from 15 to 90% w (percent by weight), in particular from 20 to 85% w, more in particular from 25 to 75% w, measured as the weight of the metal elements relative to the weight of the absorbent.

The absorbent may contain copper in a quantity of more than 8% w, preferably at least 10% w, more preferably at least 20% w, most preferably at least 25% w, measured as the weight of the copper element relative to the weight of the absorbent. The absorbent may contain copper in a quantity of at most 55% w, preferably at most 45% w, more preferably at most 40% w, measured as the weight of the copper element relative to the weight of the absorbent. The absorbent may contain copper in a quantity in the range of from 10 to 55% w (percent by weight), in particular from 15 to 50% w, measured as the weight of the copper element relative to the weight of the absorbent.

The support material may be present in the absorbent in a quantity of at least 1% w, relative to the weight of the absorbent, in particular at least 1.5% w, more in particular at least 2% w, relative to the weight of the absorbent. The support material may be present in the absorbent in a quantity of at most 80% w, relative to the weight of the absorbent, in particular at most 50% w, more in particular at most 30% w, relative to the weight of the absorbent, most in particular at most 25% w, relative to the weight of the absorbent. The support material may be present in the absorbent in a quantity in the range of from 5 to 25% w, in particular from 10 to 20% w, relative to the weight of the absorbent.

The absorbent may contain copper and zinc in a ratio of the mass of zinc present in the absorbent to the mass of copper present in the absorbent of at least 0.2, in particular at least 0.5, more in particular at least 0.7 (basis the respective elements). The mass ratio of zinc to copper may be at most 10, in particular at most 8, more in particular at most 5, same basis. The mass ratio of zinc to copper may be in the range of from 0.5 to 10, in particular from 1 to 5, more in particular from 1.2 to 2.5, most in particular from 1.25 to 1.75, same basis.

The sulfur impurities may include, but are not limited to, dihydrogen sulfide, carbonyl sulfide, mercaptans, organic sulfides, and combinations thereof. The mercaptans may include methanethiol or ethanethiol. The organic sulfides may include aromatic sulfides or alkyl sulfides, such as dimethylsulfide. Mercaptans and organic sulfides are particularly difficult sulfur impurities to remove from a feed. The absorbent, as described above, unexpectedly reduces the amount of sulfur impurities, in particular mercaptans, in a feed component even when operated at ambient temperatures.

The catalyst typically used for the epoxidation of an olefin is a catalyst comprising silver deposited on a carrier. The size and shape of the catalyst is not critical to the invention and may be in the form of chunks, pieces, cylinders, rings, spheres, wagon wheels, and the like of a size suitable for employment in a fixed bed shell-and-tube heat exchanger reactor vessel, for example from 2 mm to 20 mm.

The carrier may be based on a wide range of materials. Such materials may be natural or artificial inorganic materials and they may include refractory materials, silicon carbide, clays, zeolites, charcoal, and alkaline earth metal carbonates, for example calcium carbonate. Preferred are refractory materials, such as alumina, magnesia, zirconia, silica, and mixtures thereof. The most preferred material is α-alumina. Typically, the carrier comprises at least 85% w, more typically at least 90% w, in particular at least 95% w α-alumina, frequently up to 99.9% w α-alumina, relative to the weight of the carrier. Other components of the α-alumina carrier may comprise, for example, silica, titania, zirconia, alkali metal components, for example sodium and/or potassium components, and/or alkaline earth metal components, for example calcium and/or magnesium components.

The surface area of the carrier may suitably be at least 0.1 m²/g, preferably at least 0.3 m²/g, more preferably at least 0.5 m²/g, and in particular at least 0.6 m²/g, relative to the weight of the carrier; and the surface area may suitably be at most 10 m²/g, preferably at most 6 m²/g, and in particular at most 4 m²/g, relative to the weight of the carrier. “Surface area” as used herein is understood to relate to the surface area as determined by the B.E.T. (Brunauer, Emmett and Teller) method as described in Journal of the American Chemical Society 60 (1938) pp. 309-316. High surface area carriers, in particular when they are alpha alumina carriers optionally comprising in addition silica, alkali metal and/or alkaline earth metal components, provide improved performance and stability of operation.

The water absorption of the carrier may suitably be at least 0.2 g/g, preferably at least 0.25 g/g, more preferably at least 0.3 g/g, most preferably at least 0.35 g/g; and the water absorption may suitably be at most 0.85 g/g, preferably at most 0.7 g/g, more preferably at most 0.65 g/g, most preferably at most 0.6 g/g. The water absorption of the carrier may be in the range of from 0.2 to 0.85 g/g, preferably in the range of from 0.25 to 0.7 g/g, more preferably from 0.3 to 0.65 g/g, most preferably from 0.3 to 0.6 g/g. A higher water absorption may be in favor in view of a more efficient deposition of the metal and promoters, if any, on the carrier by impregnation. However, at a higher water absorption, the carrier, or the catalyst made therefrom, may have lower crush strength. As used herein, water absorption is deemed to have been measured in accordance with ASTM C20, and water absorption is expressed as the weight of the water that can be absorbed into the pores of the carrier, relative to the weight of the carrier.

The preparation of the catalyst comprising silver is known in the art and the known methods are applicable to the preparation of the shaped catalyst particles which may be used in the practice of this invention. Methods of depositing silver on the carrier include impregnating the carrier with a silver compound containing cationic silver and/or complexed silver and performing a reduction to form metallic silver particles. For further description of such methods, reference may be made to U.S. Pat. No. 5,380,697, U.S. Pat. No. 5,739,075, EP-A-266015, and U.S. Pat. No. 6,368,998, which methods are incorporated herein by reference. Suitably, silver dispersions, for example silver sols, may be used to deposit silver on the carrier.

The reduction of cationic silver to metallic silver may be accomplished during a step in which the catalyst is dried, so that the reduction as such does not require a separate process step. This may be the case if the silver containing impregnation solution comprises a reducing agent, for example, an oxalate, a lactate or formaldehyde.

Appreciable catalytic activity may be obtained by employing a silver content of the catalyst of at least 10 g/kg, relative to the weight of the catalyst. Preferably, the catalyst comprises silver in a quantity of from 50 to 500 g/kg, more preferably from 100 to 400 g/kg, for example 105 g/kg, or 120 g/kg, or 190 g/kg, or 250 g/kg, or 350 g/kg, on the same basis. As used herein, unless otherwise specified, the weight of the catalyst is deemed to be the total weight of the catalyst including the weight of the carrier and catalytic components.

The catalyst for use in this invention may comprise a promoter component which comprises an element selected from rhenium, tungsten, molybdenum, chromium, nitrate- or nitrite-forming compounds, and combinations thereof. Preferably the promoter component comprises, as an element, rhenium. The form in which the promoter component may be deposited onto the carrier is not material to the invention. Rhenium, molybdenum, tungsten, chromium or the nitrate- or nitrite-forming compound may suitably be provided as an oxyanion, for example, as a perrhenate, molybdate, tungstate, or nitrate, in salt or acid form.

The promoter component may typically be present in a quantity of at least 0.1 mmole/kg, more typically at least 0.5 mmole/kg, in particular at least 1 mmole/kg, more in particular at least 1.5 mmole/kg, calculated as the total quantity of the element (that is rhenium, tungsten, molybdenum and/or chromium) relative to the weight of the catalyst. The promoter component may be present in a quantity of at most 50 mmole/kg, preferably at most 10 mmole/kg, calculated as the total quantity of the element relative to the weight of the catalyst.

When the catalyst comprises rhenium as the promoter component, the catalyst may preferably comprise a rhenium co-promoter, as a further component deposited on the carrier. Suitably, the rhenium co-promoter may be selected from components comprising an element selected from tungsten, chromium, molybdenum, sulfur, phosphorus, boron, and combinations thereof. Preferably, the rhenium co-promoter is selected from tungsten, chromium, molybdenum, sulfur, and combinations thereof. It is particularly preferred that the rhenium co-promoter comprises, as an element, tungsten and/or sulfur.

The rhenium co-promoter may typically be present in a total quantity of at least 0.1 mmole/kg, more typically at least 0.25 mmole/kg, and preferably at least 0.5 mmole/kg, calculated as the element (i.e. the total of tungsten, chromium, molybdenum, sulfur, phosphorus and/or boron), relative to the weight of the catalyst. The rhenium co-promoter may be present in a total quantity of at most 40 mmole/kg, preferably at most 10 mmole/kg, more preferably at most 5 mmole/kg, on the same basis. The form in which the rhenium co-promoter may be deposited on the carrier is not material to the invention. For example, it may suitably be provided as an oxide or as an oxyanion, for example, as a sulfate, borate or molybdate, in salt or acid form.

The catalyst preferably comprises silver, the promoter component, and a component comprising a further element, deposited on the carrier. Eligible further elements may be selected from the group of nitrogen, fluorine, alkali metals, alkaline earth metals, titanium, hafnium, zirconium, vanadium, thallium, thorium, tantalum, niobium, gallium and germanium and combinations thereof. Preferably the alkali metals are selected from lithium, potassium, rubidium and cesium. Most preferably the alkali metal is lithium, potassium and/or cesium. Preferably the alkaline earth metals are selected from calcium, magnesium and barium. Typically, the further element is present in the catalyst in a total quantity of from 0.01 to 500 mmole/kg, more typically from 0.05 to 100 mmole/kg, calculated as the element on the weight of the catalyst. The further elements may be provided in any form. For example, salts of an alkali metal or an alkaline earth metal are suitable. For example, lithium compounds may be lithium hydroxide or lithium nitrate.

Preferred amounts of the components of the catalysts are, when calculated as the element, relative to the weight of the catalyst:

silver from 10 to 500 g/kg,

rhenium from 0.01 to 50 mmole/kg, if present,

the further element or elements, if present, each from 0.1 to 500 mmole/kg, and,

the rhenium co-promoter from 0.1 to 30 mmole/kg, if present.

As used herein, the quantity of alkali metal present in the catalyst is deemed to be the quantity insofar as it can be extracted from the catalyst with de-ionized water at 100° C. The extraction method involves extracting a 10-gram sample of the catalyst three times by heating it in 20 ml portions of de-ionized water for 5 minutes at 100° C. and determining in the combined extracts the relevant metals by using a known method, for example atomic absorption spectroscopy.

As used herein, the quantity of alkaline earth metal present in the catalyst is deemed to be the quantity insofar as it can be extracted from the catalyst with 10% w nitric acid in de-ionized water at 100° C. The extraction method involves extracting a 10-gram sample of the catalyst by boiling it with a 100 ml portion of 10% w nitric acid for 30 minutes (1 atm., i.e. 101.3 kPa) and determining in the combined extracts the relevant metals by using a known method, for example atomic absorption spectroscopy. Reference is made to U.S. Pat. No. 5,801,259, which is incorporated herein by reference.

Although the present epoxidation process may be carried out in many ways, it is preferred to carry it out as a gas phase process, i.e. a process in which one or more components of the feed are first contacted in the gas phase with the packed bed of absorbent to yield treated feed components, and subsequently the gaseous feed comprising the treated feed components is contacted with the packed bed of catalyst. Generally the process is carried out as a continuous process.

In addition to the olefin and oxygen, the feed components may further comprise a saturated hydrocarbon dilution gas, a reaction modifier, an inert dilution gas, and a recycle stream. Preferably, the olefin may be contacted with the absorbent in a purification zone prior to contact with the catalyst in the reaction zone. One or more of the additional feed components may also be contacted with the absorbent in the one or more purification zones either in conjunction with or separate from the olefin.

The olefin may include any olefin, such as an aromatic olefin, for example styrene, or a di-olefin, whether conjugated or not, for example 1,9-decadiene or 1,3-butadiene. Preferably, the olefin may be a monoolefin, for example 2-butene or isobutene. More preferably, the olefin may be a mono-α-olefin, for example 1-butene or propylene. The most preferred olefin is ethylene. Suitably, mixtures of olefins may be used.

The olefin may be obtained from several sources including, but not limited to, petroleum processing streams such as those generated by a thermal cracker, a catalytic cracker, a hydrocracker or a reformer, natural gas fractions, naphtha, and organic oxygenates such as alcohols. The alcohols are typically derived from the fermentation of various biomaterials including, but not limited to, sugar cane, syrup, beet juice, molasses, and other starch-based materials. An olefin, such as ethylene, derived from an alcohol prepared via a fermentation process can be a particularly troublesome source of sulfur impurities.

The quantity of olefin present in the feed may be selected within a wide range. Typically, the quantity of olefin present in the feed may be at most 80 mole-%, relative to the total feed. Preferably, it may be in the range of from 0.5 to 70 mole-%, in particular from 1 to 60 mole-%, more in particular from 5 to 40 mole-%, on the same basis.

Preferably, the saturated hydrocarbons, if any, may be contacted with the absorbent in a purification zone prior to contact with the catalyst in the reaction zone. The saturated hydrocarbon may be treated in conjunction with the olefin or separately. Saturated hydrocarbons are common dilution gases in the epoxidation process, and can be a significant source of impurities in the feed, in particular sulfur impurities. Saturated hydrocarbons, in particular methane, ethane and mixtures thereof, more in particular methane, may be present in a quantity of at most 80 mole-%, relative to the total feed, in particular at most 75 mole-%, more in particular at most 65 mole-%, on the same basis. The saturated hydrocarbons may be present in a quantity of at least 30 mole-%, preferably at least 40 mole-%, on the same basis. Saturated hydrocarbons may be added to the feed in order to increase the oxygen flammability limit.

The present epoxidation process may be air-based or oxygen-based, see “Kirk-Othmer Encyclopedia of Chemical Technology”, 3^{rd} edition, Volume 9, 1980, pp. 445-447. In the air-based process, air or air enriched with oxygen is employed as the source of the oxidizing agent while in the oxygen-based processes high-purity (at least 95 mole-%) oxygen or very high purity (at least 99.5 mole-%) oxygen is employed as the source of the oxidizing agent. Reference may be made to U.S. Pat. No. 6,040,467, incorporated by reference, for further description of oxygen-based processes. Presently most epoxidation plants are oxygen-based and this is a preferred embodiment of the present invention.

The quantity of oxygen present in the feed may be selected within a wide range. However, in practice, oxygen is generally applied in a quantity which avoids the flammable regime. Typically, the quantity of oxygen applied may be within the range of from 2 to 15 mole-%, more typically from 5 to 12 mole-%, relative to the total feed.

In order to remain outside the flammable regime, the quantity of oxygen in the feed may be lowered as the quantity of the olefin is increased. The actual safe operating ranges depend, along with the feed composition, also on the reaction conditions such as the reaction temperature and the pressure.

A reaction modifier may be present in the feed for increasing the selectively, suppressing the undesirable oxidation of olefin or olefin oxide to carbon dioxide and water, relative to the desired formation of olefin oxide. Many organic compounds, especially organic halides and organic nitrogen compounds, may be employed as the reaction modifiers. Nitrogen oxides, organic nitro compounds such as nitromethane, nitroethane, and nitropropane, hydrazine, hydroxylamine or ammonia may be employed as well. It is frequently considered that under the operating conditions of olefin epoxidation the nitrogen containing reaction modifiers are precursors of nitrates or nitrites, i.e. they are so-called nitrate- or nitrite-forming compounds (cf. e.g. EP-A-3642 and U.S. Pat. No. 4,822,900, which are incorporated herein by reference).

Organic halides are the preferred reaction modifiers, in particular organic bromides, and more in particular organic chlorides. Preferred organic halides are chlorohydrocarbons or bromohydrocarbons. More preferably they are selected from the group of methyl chloride, ethyl chloride, ethylene dichloride, ethylene dibromide, vinyl chloride or a mixture thereof. Most preferred reaction modifiers are ethyl chloride and ethylene dichloride.

Suitable nitrogen oxides are of the general formula NOₓ wherein x is in the range of from 1 to 2.5, and include for example NO, N₂O₃, N₂O₄, and N₂O₅. Suitable organic nitrogen compounds are nitro compounds, nitroso compounds, amines, nitrates and nitrites, for example nitromethane, 1-nitropropane or 2-nitropropane. In preferred embodiments, nitrate- or nitrite-forming compounds, e.g. nitrogen oxides and/or organic nitrogen compounds, are used together with an organic halide, in particular an organic chloride.

The reaction modifiers are generally effective when used in small quantities in the feed, for example at most 0.1 mole-%, relative to the total feed, for example from 0.01×10⁻⁴ to 0.01 mole-%. In particular when the olefin is ethylene, it is preferred that the reaction modifier is present in the feed in a quantity of from 0.1×10⁻⁴ to 500×10⁻⁴ mole-%, in particular from 0.2×10⁻⁴ to 200×10⁻⁴ mole-%, relative to the total feed.

Inert dilution gases, for example nitrogen, helium or argon, may be present in the feed in a quantity of from 30 to 90 mole-%, typically from 40 to 80 mole-%, relative to the total feed.

A recycle stream may be used as a feed component in the epoxidation process. The reaction product comprises the olefin oxide, unreacted olefin, unreacted oxygen, reaction modifier, dilution gases, and, optionally, other reaction by-products such as carbon dioxide and water. The reaction product is passed through one or more separation systems, such as an olefin oxide absorber and a carbon dioxide absorber, so the unreacted olefin and oxygen may be recycled to the reactor system. Carbon dioxide is a by-product in the epoxidation process. However, carbon dioxide generally has an adverse effect on the catalyst activity. Typically, a quantity of carbon dioxide in the feed in excess of 25 mole-%, in particular in excess of 10 mole-%, relative to the total feed, is avoided. A quantity of carbon dioxide of less than 3 mole-%, preferably less than 2 mole-%, more preferably less than 1 mole-%, relative to the total feed, may be employed. Under commercial operations, a quantity of carbon dioxide of at least 0.1 mole-%, in particular at least 0.2 mole-%, relative to the total feed, may be present in the feed.

The temperature of the absorbent may be at least 0° C., in particular at least 10° C., more in particular at least 20° C. The temperature of the absorbent may be at most 350° C., in particular at most 200° C., more in particular at most 50° C. Suitably, the temperature of the absorbent may be at ambient temperature. When operating at low temperatures, any acetylene impurities in the feed components should be removed prior to contact with the absorbent to minimize the formation of acetylides.

The epoxidation process may be carried out using reaction temperatures selected from a wide range. Preferably, the reaction temperature is in the range of from 150 to 325° C., more preferably in the range of from 180 to 300° C.

The epoxidation process is preferably carried out at a reactor inlet pressure in the range of from 1000 to 3500 kPa. “GHSV” or Gas Hourly Space Velocity is the unit volume of gas at normal temperature and pressure (0° C., 1 atm, i.e. 101.3 kPa) passing over one unit volume of packed catalyst per hour. Preferably, when the epoxidation process is a gas phase process involving a packed catalyst bed, the GHSV is in the range of from 1500 to 10000 Nl/(l.h). Preferably, the process is carried out at a work rate in the range of from 0.5 to 10 kmole olefin oxide produced per m³ of catalyst per hour, in particular 0.7 to 8 kmole olefin oxide produced per m³ of catalyst per hour, for example 5 kmole olefin oxide produced per m³ of catalyst per hour. As used herein, the work rate is the amount of the olefin oxide produced per unit volume of catalyst per hour and the selectivity is the molar quantity of the olefin oxide formed relative to the molar quantity of the olefin converted. As used herein, the activity is a measurement of the temperature required to achieve a particular ethylene oxide production level. The lower the temperature, the better the activity.

The olefin oxide produced may be recovered from the reaction product by using methods known in the art, for example by absorbing the olefin oxide from a reactor outlet stream in water and optionally recovering the olefin oxide from the aqueous solution by distillation. At least a portion of the aqueous solution containing the olefin oxide may be applied in a subsequent process for converting the olefin oxide into a 1,2-diol, a 1,2-diol ether, a 1,2-carbonate, or an alkanolamine.

The olefin oxide produced in the epoxidation process may be converted into a 1,2-diol, a 1,2-diol ether, a 1,2-carbonate, or an alkanolamine. As this invention leads to a more attractive process for the production of the olefin oxide, it concurrently leads to a more attractive process which comprises producing the olefin oxide in accordance with the invention and the subsequent use of the obtained olefin oxide in the manufacture of the 1,2-diol, 1,2-diol ether, 1,2-carbonate, and/or alkanolamine.

The conversion into the 1,2-diol or the 1,2-diol ether may comprise, for example, reacting the olefin oxide with water, suitably using an acidic or a basic catalyst. For example, for making predominantly the 1,2-diol and less 1,2-diol ether, the olefin oxide may be reacted with a ten fold molar excess of water, in a liquid phase reaction in presence of an acid catalyst, e.g. 0.5-1.0% w sulfuric acid, based on the total reaction mixture, at 50-70° C. at 1 bar absolute, or in a gas phase reaction at 130-240° C. and 20-40 bar absolute, preferably in the absence of a catalyst. The presence of such a large quantity of water may favor the selective formation of 1,2-diol and may function as a sink for the reaction exotherm, helping control the reaction temperature. If the proportion of water is lowered, the proportion of 1,2-diol ethers in the reaction mixture is increased. The 1,2-diol ethers thus produced may be a di-ether, tri-ether, tetra-ether or a subsequent ether. Alternative 1,2-diol ethers may be prepared by converting the olefin oxide with an alcohol, in particular a primary alcohol, such as methanol or ethanol, by replacing at least a portion of the water by the alcohol.

The olefin oxide may be converted into the corresponding 1,2-carbonate by reacting it with carbon dioxide. If desired, a 1,2-diol may be prepared by subsequently reacting the 1,2-carbonate with water or an alcohol to form the 1,2-diol. For applicable methods, reference is made to U.S. Pat. No. 6,080,897, which is incorporated herein by reference.

The conversion into the alkanolamine may comprise, for example, reacting the olefin oxide with ammonia. Anhydrous ammonia is typically used to favor the production of monoalkanolamine. For methods applicable in the conversion of the olefin oxide into the alkanolamine, reference may be made to, for example U.S. Pat. No. 4,845,296, which is incorporated herein by reference.

The 1,2-diol and the 1,2-diol ether may be used in a large variety of industrial applications, for example in the fields of food, beverages, tobacco, cosmetics, thermoplastic polymers, curable resin systems, detergents, heat transfer systems, etc. The 1,2-carbonates may be used as a diluent, in particular as a solvent. The alkanolamine may be used, for example, in the treating (“sweetening”) of natural gas.

Unless specified otherwise, the low-molecular weight organic compounds mentioned herein, for example the olefins, 1,2-diols, 1,2-diol ethers, 1,2-carbonates, alkanolamines, and reaction modifiers, have typically at most 40 carbon atoms, more typically at most 20 carbon atoms, in particular at most 10 carbon atoms, more in particular at most 6 carbon atoms. As defined herein, ranges for numbers of carbon atoms (i.e. carbon number) include the numbers specified for the limits of the ranges.

Having generally described the invention, a further understanding may be obtained by reference to the following examples, which are provided for purposes of illustration only and are not intended to be limiting unless otherwise specified.

### EXAMPLES

### Example 1

Into a stainless steel U-shaped tube of internal diameter 4.8 mm was placed 1 g of Absorbent A that had been ground to a size range of 14-20 mesh. Absorbent A was fixed in the tube by means of glass wool plugs. The tube was suspended in ambient air and maintained at a temperature of approximately 30° C. for the duration of this experiment.

Absorbent A, after calcination, had a content of about 36% w copper oxide, about 48% w zinc oxide, and about 16% w alumina.

The following is a prophetic co-precipitation method which may be used to prepare Absorbent A above. A solution of metal nitrates is prepared by dissolving metal components of aluminum, copper and zinc (in that order) in dilute nitric acid. The amount of the metal components are such as to yield a finished precipitate after calcination of about 36% w CuO; about 48% w ZnO; and about 16% w Al₂O₃. A soda solution (160-180 g/l) is prepared and transferred to a precipitation vessel. The soda solution is heated to 80° C. The mixed nitrate solution is then added to the soda solution over approximately 2 hours while stirring. During the precipitation process, the temperature is adjusted to keep the temperature at approximately 80° C. The precipitation is stopped once a pH of 8.0 (+0.2) is achieved. The stirring of the slurry is continued for 30 minutes at 80° C. and the pH measured again (the pH can be adjusted, if necessary, by the addition of the soda solution or the nitrate solution). The concentration of the oxide in the slurry is approximately 60 grams of oxide per liter of slurry. The precipitate is then filtered and washed. The precipitate is then dried at a temperature in the range of from 120-150° C. and then calcined at a temperature of 400-500° C. The precipitate is then formed into 5×5 mm tablets.

The tablets are then reduced using diluted hydrogen (0.1 to 10% volume H₂ in N₂) at 190 to 250° C. The reduced tablets are then stabilized using dilute oxygen (0.1 to 10% volume O₂ in N₂) at a maximum temperature of 80° C.

Absorbent A was then tested by introducing a gaseous mixture comprising 257 ppmv dihydrogen sulfide in a balance of nitrogen into a flow of ethylene to provide a resulting concentration of 23 ppmv dihydrogen sulfide, relative to the ethylene. This mixture of ethylene, nitrogen and dihydrogen sulfide was directed through the U-shaped tube containing 1 g Absorbent A at a flow rate of 89 cc/min. The gas exiting this first U-shaped tube was then mixed with other feedstock components to yield a combined feedstock consisting of 22% v C₂H₄, 7% v O₂, 5% v CO₂, 2.5 ppmv ethyl chloride, balance N₂, plus any dihydrogen sulfide that was not absorbed by Absorbent A.

The combined feedstock was directed at a flow rate of 400 cc/min through a second stainless steel U-shaped tube of internal diameter 4.8 mm that contained 0.5 g of a catalyst which contained 14.5% w silver, 500 ppmw cesium deposited on an alpha-alumina carrier. This second U-shaped tube was maintained at 230° C. and 210 psig (1447 kPa). The function of the catalyst was to serve as a capture bed for any dihydrogen sulfide that was not absorbed by the Absorbent A bed. Silver reacts strongly with many sulfur-containing species under the conditions maintained in the second U-shaped tube. Thus, the catalyst was used to react with, and thus allow quantification of, any dihydrogen sulfide that indeed penetrated through the Absorbent A bed.

After 41 hours, the first catalyst tube was removed for chemical analysis. Subsequently, each catalyst tube was replaced by a fresh catalyst tube for a new time interval ranging from 24 to 168 hours.

For each catalyst tube removed, the catalyst was crushed to a fine powder, thoroughly mixed, and then analyzed by x-ray photoelectron spectroscopy (XPS) to quantify the amount of sulfur that had penetrated the upstream absorbent bed and reacted with the catalyst.

A standardization curve was constructed that related the strength of the XPS sulfur signal on the catalyst to the known amount of dihydrogen sulfide to which the catalyst had been exposed. To construct the standardization curve, different concentrations of dihydrogen sulfide were metered into the ethylene, which was then mixed with the other feedstock components and then directed through a U-shaped tube containing the catalyst. In this manner, a standardization curve was constructed that correlated x-ray photoelectron spectroscopy (XPS) signal intensities with total sulfur exposure. This standardization curve was employed to quantify the amount of the sulfur that had penetrated the absorbent bed and reacted with the catalyst.

Example 1 continued for 1134 hours. At the end of the 1134 hours, it was determined, based on the total amount of sulfur introduced into the gaseous mixture and the total amount of sulfur reacted with the catalyst, that Absorbent A had removed from the gaseous mixture an amount of dihydrogen sulfide equivalent to 17.4% w sulfur relative to the mass of Absorbent A. Results for this and other Examples are summarized in Table I.

### Example 2

### For Comparison

Example 2 was conducted in substantially the same manner as Example 1, except that Absorbent B was used instead of Absorbent A. Absorbent B had a content of about 8% w copper oxide, about 3% w chromium oxide, and about 89% w activated carbon. Example 2 continued for 477 hours. At the conclusion of the 477 hour time period, it was determined that Absorbent B had removed from the gaseous mixture an amount of dihydrogen sulfide equivalent to 6.2% w sulfur relative to the mass of Absorbent B.

### Example 3

### For Comparison

Example 3 was conducted in substantially the same manner as Example 1, except that Absorbent C was used instead of Absorbent A. Absorbent C had a content of about 20% w copper oxide, about 30% w manganese oxide, and about 50% w alumina. Example 3 continued for 626 hours. At the end of the 626 hours, it was determined that Absorbent C had removed from the gaseous mixture an amount of dihydrogen sulfide equivalent to 8.6% w sulfur relative to the mass of Absorbent C.

### Example 4

Example 4 was conducted in substantially the same manner as Example 1, except that methanethiol served as the sulfur source rather than dihydrogen sulfide. A gaseous mixture comprising 56 ppmv methanethiol in a balance of nitrogen was introduced into a flow of ethylene to provide a resulting concentration of 14 ppmv methanethiol, relative to the ethylene. In Example 4, the U-shaped tube contained 2 g Absorbent A that had been crushed to 14-20 mesh size. Example 4 continued for 617 hours. At the end of the 617 hours, it was determined that Absorbent A had removed from the gaseous mixture an amount of methanethiol equivalent to 1.5% w sulfur relative to the mass of Absorbent A.

### Example 5

### For Comparison

Example 5 was conducted in substantially the same manner as Example 4, except that Absorbent B was used instead of Absorbent A. Example 5 continued for 307 hours. At the end of the 307 hours, it was determined that Absorbent B had removed from the gaseous mixture an amount of methanethiol equivalent to 0.3% w sulfur relative to the mass of Absorbent B.

### Example 6

### For Comparison

Example 6 was conducted in substantially the same manner as Example 4, except that Absorbent C was used instead of Absorbent A. Example 6 continued for 93 hours. At the end of the 93 hours, Absorbent C had removed from the gaseous mixture an amount of methanethiol equivalent to less than 0.3% w sulfur relative to the mass of Absorbent B.

### Example 7

Example 7 was conducted in substantially the same manner as Example 1, except that carbonyl sulfide served as the sulfur source rather than dihydrogen sulfide. A gaseous mixture comprising 50 ppmv carbonyl sulfide in a balance of nitrogen was introduced into a flow of ethylene to provide a resulting concentration of 13 ppmv carbonyl sulfide, relative to the ethylene. Example 7 continued for 1208 hours. At the end of the 1208 hours, it was determined that Absorbent A had removed from the gaseous mixture an amount of carbonyl sulfide equivalent to 16.4% w sulfur relative to the mass of Absorbent A.

### Example 8

### For Comparison

Example 8 was conducted in substantially the same manner as Example 7, except that Absorbent B was used instead of Absorbent A. Example 8 continued for 281 hours. At the end of the 281 hours, it was determined that Absorbent B had removed from the gaseous mixture an amount of carbonyl sulfide equivalent to 2.2% w sulfur relative to the mass of Absorbent B.

### Example 9

### For Comparison

Example 9 was conducted in substantially the same manner as Example 7, except that Absorbent C was used instead of Absorbent A. Example 9 continued for 475 hours. At the end of the 475 hours, it was determined that Absorbent C had removed from the gaseous mixture an amount of carbonyl sulfide equivalent to 3.5% w sulfur relative to the mass of Absorbent C.

### Example 10

Example 10 was conducted in substantially the same manner as Example 1, except that dimethylsulfide served as the sulfur source rather than dihydrogen sulfide. A gaseous mixture comprising 50 ppmv dimethylsulfide in a balance of nitrogen was introduced into a flow of ethylene to provide a resulting concentration of 5 ppmv dimethylsulfide, relative to the ethylene. In Example 10, the U-shaped tube contained 4 g Absorbent A that had been crushed to 14-20 mesh size. Example 10 continued for 255 hours. At the end of the 255 hours, Absorbent A had removed from the gaseous mixture an amount of dimethylsulfide equivalent to 0.05% w sulfur relative to the mass of Absorbent A.

### Example 11

### For Comparison

Example 11 was conducted in substantially the same manner as Example 10, except that Absorbent B was used instead of Absorbent A. Example 11 continued for 87 hours. At the end of the 87 hours, it was determined that Absorbent B had removed from the gaseous mixture an amount of dimethylsulfide equivalent to 0.03% w sulfur relative to the mass of Absorbent B.

### Example 12

### For Comparison

Example 12 was conducted in substantially the same manner as Example 10, except that Absorbent C was used instead of Absorbent A. Example 12 continued for 24 hours. Absorbent C was not effective at removing sulfur even during the first exposure interval, removing an amount of dimethylsulfide equivalent to less than 0.02% w sulfur relative to the mass of Absorbent C.

The objective of the above examples was to demonstrate that Absorbent A was significantly more effective at reducing the quantity of sulfur compound in a gaseous mixture than the comparative absorbents. Therefore, the tests using Absorbent A were sometimes discontinued once the effectiveness was demonstrated over the comparative absorbents even though there may not have been a greater than 95% breakthrough of the sulfur compound (i.e., the absorbent still had remaining capacity to remove sulfur). For the comparative examples, there was greater than 95% breakthrough of the sulfur compound at the end of the test period.

TABLE I

| | | Metal | | | | |
|---|---|---|---|---|---|---|
| | | Components | | Duration of Test | Sorption Amount¹ | |
| Example | Absorbent | of Absorbent | Sulfur Source | (hours) | (% W S) | Percent Breakthrough² |
| 1 | A | Cu + Zn | dihydrogen sulfide | 1134 | 17.4 | >95 |
| 2 | B | Cu + Cr | dihydrogen sulfide | 477 | 6.2 | >95 |
| 3 | C | Cu + Mn | dihydrogen sulfide | 626 | 8.6 | >95 |
| 4 | A | Cu + Zn | methanethiol | 617 | 1.5 | 35 |
| 5 | B | Cu + Cr | methanethiol | 307 | 0.3 | >95 |
| 6 | C | Cu + Mn | methanethiol | 93 | <0.3 | >95 |
| 7 | A | Cu + Zn | carbonyl sulfide | 1208 | 16.4 | 45 |
| 8 | B | Cu + Cr | carbonyl sulfide | 281 | 2.2 | >95 |
| 9 | C | Cu + Mn | carbonyl sulfide | 475 | 3.5 | >95 |
| 10 | A | Cu + Zn | dimethylsulfide | 255 | 0.05 | 90 |
| 11 | B | Cu + Cr | dimethylsulfide | 87 | 0.03 | >95 |
| 12 | C | Cu + Mn | dimethylsulfide | 24 | <0.02 | >95 |

¹Sorption Amount is the percent by weight of sulfur captured by the absorbent relative to the weight of the absorbent at the end of the testing period
²Percent Breakthrough is the percentage of sulfur fed that was not absorbed by the guard bed during the final interval of testing

The data in Table I demonstrate that, for all four chemical forms of inorganic and organic sulfur that were evaluated, Absorbent A exhibited significantly superior sulfur removal capacity as compared to Absorbent B and Absorbent C.

What is claimed is:

1. An epoxidation reactor system for preparing an olefin oxide comprising:
one or more purification zones comprising one or more purification vessels containing an absorbent comprising copper and zinc; and
a reaction zone comprising one or more reactor vessels containing an epoxidation catalyst, wherein the reaction zone is positioned downstream from the one or more purification zones.

2. The reactor system as claimed in claim 1, wherein the absorbent further comprises an additional metal selected from the group consisting of cobalt, chromium, lead, manganese, and nickel.

3. The reactor system as claimed in claim 1, wherein the absorbent further comprises an additional metal selected from the group consisting of chromium, manganese and nickel.

4. The reactor system as claimed in claim 1, wherein the absorbent further comprises a support material selected from the group consisting of alumina, titania, silica, activated carbon, and mixtures thereof.

5. The reactor system as claimed in claim 4, wherein the support material is present in a quantity of 2 to 80% w, relative to the weight of the absorbent.

6. The reactor system as claimed in claim 1, wherein the catalyst comprises silver.

7. A process for preparing an olefin oxide by reacting a feed comprising one or more feed components comprising an olefin and oxygen, which process comprises:
contacting one or more of the feed components with an absorbent comprising copper and zinc positioned within an epoxidation reactor system as claimed in claim 1 to reduce the quantity of one or more impurities in the feed components; and
subsequently contacting the feed components with an epoxidation catalyst to yield an olefin oxide.

8. The process as claimed in claim 7, wherein the one or more impurities comprise one or more sulfur impurities selected from the group consisting of dihydrogen sulfide, carbonyl sulfide, mercaptans, organic sulfides, and combinations thereof.

9. The process as claimed in claim 7, wherein the one or more impurities comprise a mercaptan.

10. The process as claimed in claim 9, wherein the mercaptan comprises ethanethiol or methanethiol.

11. The process as claimed in claim 7, wherein the one or more impurities comprise carbonyl sulfide.

12. The process as claimed in claim 7, wherein the one or more impurities comprise dihydrogen sulfide.

13. The process as claimed in claim 7, wherein the olefin comprises ethylene.

14. The process as claimed in claim 13, wherein the ethylene is derived from an organic oxygenate prepared via fermentation of a biomass material.

15. The process as claimed in claim 7, wherein the one or more feed components are contacted with the absorbent at a temperature in the range of from 20 to 200° C.

16. The process as claimed in claim 7, wherein the one or more feed components are contacted with the absorbent at a temperature of at most 50° C.

17. The process as claimed in claim 7, wherein the one or more feed components further comprise a saturated hydrocarbon.

18. The process as claimed in claim 17, wherein the saturated hydrocarbon comprises methane and the methane feed component is contacted with the absorbent.

19. The process as claimed in claim 7, wherein the one or more feed components further comprise a recycle stream.

20. The process as claimed in claim 7, wherein the absorbent further comprises a support material selected from the group consisting of alumina, titania, silica, activated carbon, and mixtures thereof.

21. A process for preparing a 1,2-diol, a 1,2-diol ether, a 1,2-carbonate, or an alkanolamine comprising converting an olefin oxide into the 1,2-diol, the 1,2-diol ether, the 1,2-carbonate, or the alkanolamine wherein the olefin oxide has been prepared by the process as claimed in claim 7.
